(19) United States
(12) Patent Application Publication
(10) Pub. No.: US 2019/0033843 A1
(43) Pub. Date: Jan. 31, 2019

(54) SYSTEM AND METHOD FOR DETECTING ABNORMAL OPERATING CONDITION OF GENSET POWER SYSTEM COMPONENT

(71) Applicant: Caterpillar Inc., Peoria, IL (US)

(72) Inventors: Yanchai Zhang, Dunlap, IL (US); Maurice Dust, Edwards, IL (US); Perry D Converse, Lafayette, IN (US); Xuefei Hu, Dunlap, IL (US); Zhaoxu Dong, Dunlap, IL (US); Yong Sun, Dunlap, IL (US)

(21) Appl. No.: 15/660,014

(22) Filed: Jul. 26, 2017

(51) Int. Cl. G05B 23/02; G01N 29/12; G01N 29/44; G01M 1/14; H02K 7/18; H02K 11/20

(52) U.S. Cl. CPC G05B 23/0289; G01N 29/12; H02K 11/20; G01M 1/14; H02K 7/1815; G01N 29/4454

(57) ABSTRACT

A system for detecting an abnormal operating condition of a component of a genset power system, which includes an engine drivingly coupled to a generator, is provided. The system also includes at least one vibration sensor configured to measure vibrations of the genset power system, and a controller. The controller is programmed to receive vibration sensor data from the vibration sensor, and process the vibration sensor data using a modeling software to generate simulated data. The simulated data is filtered using frequency-based filtering to obtain filtered data, and frequency domain information of the filtered data is compared to threshold data to identify the abnormal operating condition of the component.

### TECHNICAL FIELD

The present disclosure relates generally to detection of an abnormal operating condition of a genset power system component and, more particularly, to model-based detection including frequency-based filtering.

### BACKGROUND

An engine-driven generator, commonly referred to as a genset or a genset power system, is the combination of an engine (such as a diesel-powered or gas-powered internal combustion engine) with a generator (such as an alternator) to generate electrical power. That is, the engine may generate a mechanical power output, and the generator may be coupled to the engine to convert at least a portion of the mechanical power output to electrical power. According to an example, a diesel internal combustion engine may provide the mechanical power output in a genset, and may be designed to run on conventional fuels, or may be adapted for use with other liquid fuels or natural gas. Gensets may be used for prime, continuous, or standby power, and may be implemented in various applications, including applications using single gensets and applications using a plurality of gensets, such as to provide redundancy and/or load sharing.

Excessive loading, and/or other undesirable operating conditions, of a genset can cause vibrations, which may result in undesirable effects on components of the genset. For example, excessive loading may cause premature wear or failure of genset components, which may result in unplanned downtime for the genset. Thus, to optimize operation thereof, it may be desirable to accurately and effectively detect or predict the occurrence of various abnormal operating conditions of the genset, which may result in undesirable effects on genset components, such that actions may be taken to reduce the undesirable effects on the genset.

U.S. Pat. No. 8,994,359 to Neti et al. (hereinafter “Neti”) discloses a method of detecting faults in a wind turbine generator based on current signature analysis. In particular, electrical signals representative of operating conditions of the wind turbine generator are processed to generate a normalized spectrum of electrical signals. A fault related to a generator component is detected by analyzing the normalized spectrum.

### SUMMARY OF THE INVENTION

In one aspect, a system for detecting an abnormal operating condition of a component of a genset power system, which includes an engine drivingly coupled to a generator, is provided. The system includes at least one vibration sensor configured to measure vibrations of the genset power system, and a controller. The controller is programmed to receive vibration sensor data from the vibration sensor, and process the vibration sensor data using a modeling software to generate simulated data. The simulated data is filtered using frequency-based filtering to obtain filtered data, and frequency domain information of the filtered data is compared to threshold data to identify the abnormal operating condition of the component.

In another aspect, a method for detecting an abnormal operating condition of a component of a genset power system is provided. The genset power system includes an engine drivingly coupled to a generator. The method includes operating the genset power system to produce an electrical output, measuring vibrations of the genset power system using a vibration sensor, generating vibration sensor data using the vibration sensor, and receiving vibration sensor data from the vibration sensor at a controller. The controller processes the vibration sensor data using a modeling software to generate simulated data, filters the simulated data using frequency-based filtering to obtain filtered data, and compares frequency domain information of the filtered data to threshold data to identify the abnormal operating condition.

In yet another aspect, a control system for detecting an abnormal operating condition of a component of a genset power system is provided. The genset power system includes an engine drivingly coupled to a generator. The control system includes a controller programmed to receive vibration sensor data from a vibration sensor configured to measure vibrations of the genset power system, and process the vibration sensor data using a modeling software to generate simulated data. The controller is also programmed to filter the simulated data using frequency-based filtering to obtain filtered data, and compare frequency domain information of the filtered data to threshold data to identify the abnormal operating condition.

### BRIEF DESCRIPTION OF THE DRAWINGS

FIG. 1 is a schematic diagram of an exemplary genset power system and a system for detecting an abnormal operating condition of a component of the genset power system, according to an exemplary embodiment of the present disclosure;

FIG. 2 illustrates a front bearing bracket of a generator, which may be a mounting location for a first vibration sensor, according to one aspect of the present disclosure;

FIG. 3 illustrates a rear bearing bracket of a generator, which may be a mounting location for a second vibration sensor, according to another aspect of the present disclosure;

FIG. 4 is a flow diagram representing an exemplary method for detecting an abnormal operating condition of a component of the genset power system of FIG. 1;

FIG. 5 is a block diagram further illustrating the exemplary method of FIG. 4, including charts depicting exemplary vibration sensor data;

FIG. 6 illustrates exemplary mounting locations for various vibration sensors of the present disclosure, as identified by exemplary modeling software described herein;

FIG. 7 is a flow diagram representing another exemplary method for detecting an abnormal operating condition of a genset power system component, according to the teachings of the present disclosure;

FIG. 8 are charts depicting exemplary vibration sensor data, according to various aspects of the present disclosure;

FIG. 9 illustrates a power system including a plurality of genset power systems, according to another exemplary embodiment of the present disclosure; and

FIG. 10 is a block diagram of an exemplary health monitor system for a genset power system, including aspects of the system and method for detecting an abnormal operating condition of a genset power system component, as described herein.

### DETAILED DESCRIPTION

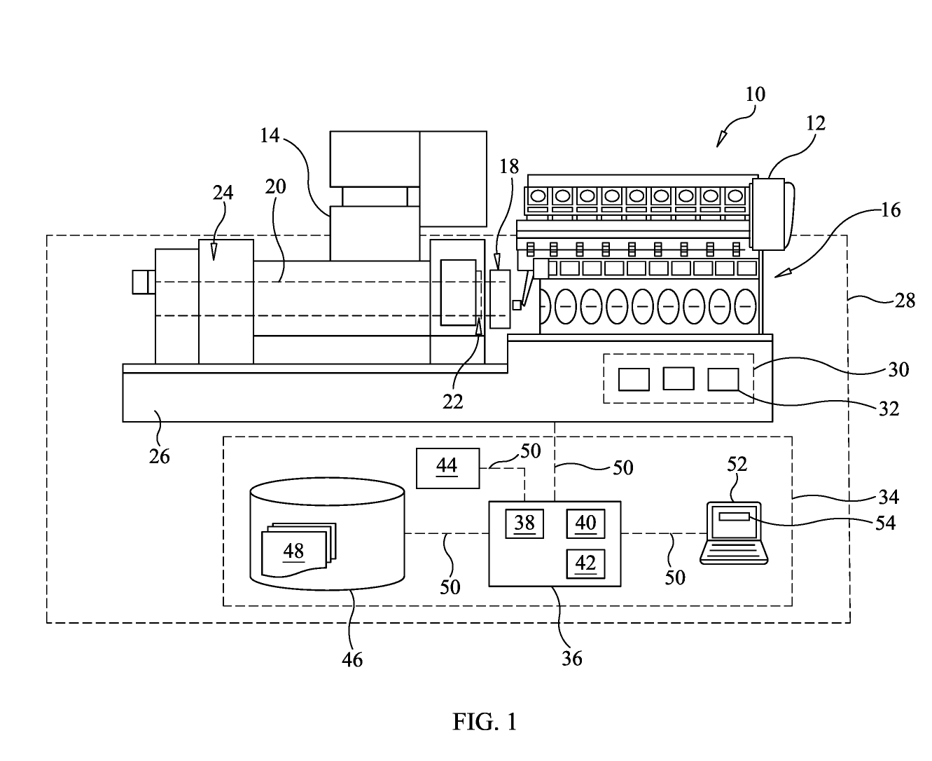

An exemplary genset power system 10 according to the present disclosure is shown generally in FIG. 1. The genset power system 10 may include any component or components that operate to generate electrical power for a load (not shown). The load may include any type of power consuming system or device configured to receive and/or utilize electrical power to perform some type of work or task. The genset power system 10 may be used for prime, continuous, or standby power, and may be implemented in various applications, including applications using single gensets and applications using a plurality of gensets, such as applications requiring redundancy and/or load sharing.

The genset power system 10 may include an engine 12 drivingly coupled to a generator 14. The engine 12 may be any of a variety of known engines configured to produce mechanical power and, for example, may include an internal combustion engine such as a diesel-powered or gasoline-powered engine. As should be appreciated by those skilled in the art, the engine 12 may include a plurality of cylinders, each having a piston connected to a common crankshaft 16. The engine 12 may be mechanically coupled to the generator 14 via a coupling 18. In particular, the crankshaft 16 may be directly or indirectly coupled to the generator 14 via the coupling 18.

The generator 14 may be any type of known device configured to receive mechanical power from the engine 12, by way of the coupling 18, and convert at least a portion of the mechanical power into electrical power, in known ways. For example, the generator 14 may be a variable-frequency alternating current generator, a fixed frequency alternating current generator, an induction generator, a permanent-magnet generator, a switched-reluctance generator, and/or any other generator. That is, a rotor 20, which is a moving component of the generator 14, may produce a rotating magnetic field in one of various ways, such as, for example, by induction, by permanent magnets, or by using an exciter. Among other additional components, the generator 14 may also include a front bearing 22 and a rear bearing 24, for use in a known manner, to constrain relative motion and reduce friction between moving parts.

The genset power system 10 may be mounted, or otherwise supported, on a structural support, such as a vibration isolation mount 26. The vibration isolation mount 26 may function as a vibration isolator and a shock mount for the genset power system 10 and various components thereof. The genset power system 10 may include various additional components, as will be appreciated by those skilled in the art, such as, for example, a fuel system, a voltage regulator, cooling and exhaust systems, and/or a lubrication system, to name a few.

A system for detecting an abnormal operating condition of a component of the genset power system 10, according to the present disclosure, is shown generally at 28. As illustrated, the system 28 may include one or more components of the genset power system 10. For example, the system 28 may include various sensors 30 that may be mounted on the genset power system 10 and used to monitor and/or control operation of the genset power system 10. According to one example, the system 28 may include, or may communicate with, at least one vibration sensor 32, such as an accelerometer, configured to measure vibrations of the genset power system 10. According to another example, the system 28 may include a plurality of vibration sensors 32 positioned at various predetermined locations of the genset power system 10, as will be described herein, for monitoring vibrations at the various predetermined locations. Although vibration sensors 32 are described, it should be appreciated that the sensors 30 of the genset power system 10 may include various other sensors, including, for example, speed sensors, pressure sensors, temperature sensors, and/or the like.

The system 28 may also include a control system 34, including a controller 36, for electronically monitoring and/or controlling the various machine systems and components. The controller 36 may include a processor 38, such as, for example, a high frequency processor, a memory 40, and an input/output circuit that facilitates communication internal and external to the controller 36. The processor 38, for example, may control operation of the controller 36 by executing operating instructions, such as, for example, computer readable program code 42 stored in the memory 40, wherein operations may be initiated internally or externally to the controller 36.

Control schemes may be utilized that monitor outputs of systems or devices, such as, for example, sensors (e.g., sensors 30 introduced above), actuators, and/or control units, via the input/output circuit to control inputs to various other systems or devices. Memory 40, as used herein, may comprise temporary storage areas, such as, for example, cache, virtual memory, or random-access memory, or permanent storage areas, such as, for example, read-only memory, removable drives, network/internet storage, hard drives, flash memory, memory sticks, and/or any other volatile or non-volatile data storage devices.

According to the present disclosure, the control system 34 may include or access modeling software 44 for performing a variety of functions or tasks. For example, the modeling software 44 may represent a set of software modules or programs for processing data, monitoring operations, and/or performing simulations using mathematical models. According to the present disclosure, the modeling software 44 may be used to assist in detecting abnormal operating conditions of components of the genset power system 10.

The control system 34 may also include or access a database 46. The database 46, and/or memory 40, may be accessed by the controller 36 to implement various monitoring and/or control strategies for the genset power system 10. According to some embodiments, the controller 36 may utilize models 48, generated by the modeling software 44, and/or other data to perform various functions or tasks, including assisting in detecting abnormal operating conditions of genset power system components, as will be described in more detail below.

The controller 36 may be configured to communicate with the database 46, the modeling software 44, and various components of the genset power system 10 including, for example, the at least one vibration sensor 32 via communication lines 50. The controller 36 may also communicate with an operator interface 52, via communication lines 50, through which an operator may monitor and/or control one or more aspects of the operation of the genset power system 10 and/or system 28. According to a specific example, the operator interface 52 may communicate or display a message 54, which has been generated by the controller 36, corresponding to an abnormal operating condition detected by the system 28. The message 54 may be stored or logged in the memory 40 or database 46, for example. The message 54 may communicate a problem or potential problem with a component of the genset power system 10. In response, various actions may be taken. For example, maintenance/repair may be initiated, the genset power system 10 may be shut down or taken off-line, and/or a costly failure may be avoided. Actions may be taken automatically and/or manually.

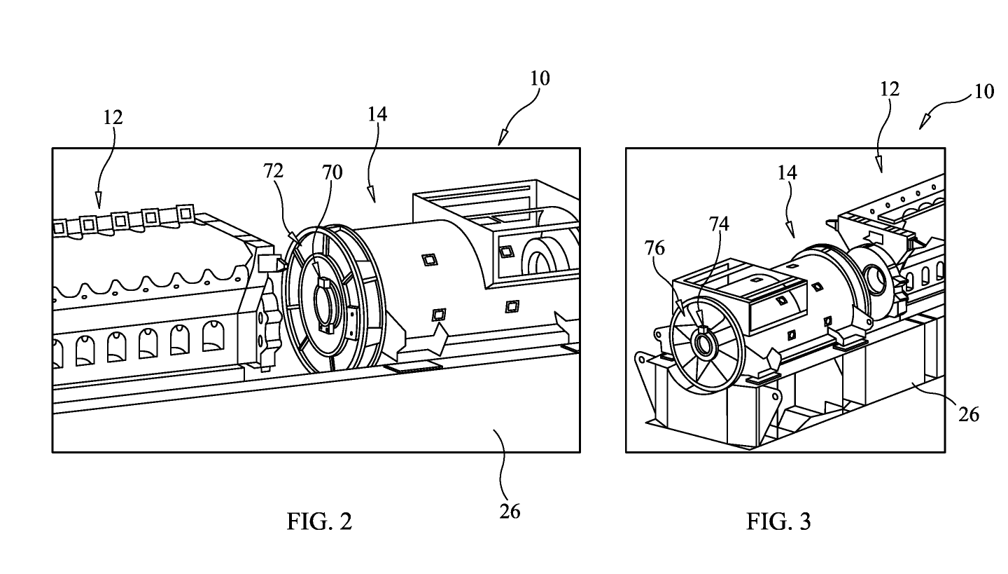

According to a specific example of the present disclosure, and referring also to FIGS. 2 and 3, the controller 36 may be programmed to identify wear or failure, or another abnormal operating condition, of one or both of the front and rear bearings 22, 24 of the genset power system 10. A first sensor 70, which may be a vibration sensor, or accelerometer, may be mounted on a front generator bearing bracket 72, as shown in FIG. 2. In addition, a second sensor 74, which may also be a vibration sensor, or accelerometer, may be mounted on a rear generator bearing bracket 76, as shown in FIG. 3. As stated, the first sensor 70 and the second sensor 74 may be accelerometers or other sensors measuring acceleration or vibration at or near the respective mounting locations.

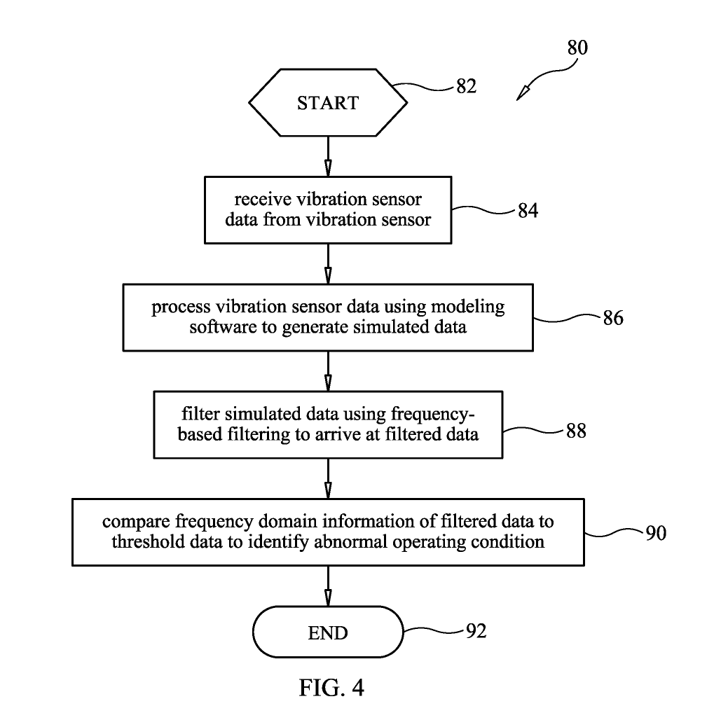

The controller 36 may communicate with the first sensor 70 and the second sensor 74, and other components of the genset power system 10, and may be programmed to identify wear and/or failure of the front bearing 22 and/or rear bearing 24 of the genset power system 10, according to a method disclosed herein, the steps of which are illustrated in a flow diagram 80 of FIG. 4. Generally speaking the wear and/or failure may be identified by evaluating vibration sensor data at the one or more predetermined mounting locations, which have been identified as being most sensitive to the wear or failure of the particular component. The method, the steps of which may be performed in an alternative order, may be implemented in whole or in part by the controller 36 and may run, or execute, continuously or intermittently. The method may begin at a START, at box 82, and proceed to box 84.

According to the exemplary embodiment, vibration sensor data may be generated by the first sensor 70 and the second sensor 74, such as during operation of the genset power system 10, and may be received at the controller 36, at box 84. For example, the vibration sensor data, which may be in the form of time domain measurement data, may be transmitted from at least one of the first and second sensors 70 and 74 to the controller 36 via communication lines 50. The vibration sensor data from the first sensor 70 may be representative of vibrations at or near the front bearing 22, while vibration sensor data from the second sensor 74 may be representative of vibrations at or near the rear bearing 24. Excessive vibrations (or vibrations outside a normal range) at or near these locations may indicate an abnormal operating condition, such as wear or failure, at one or both of the front and rear bearings 22, 24.

Processing of the vibration sensor data may include one or more of noise filtering, signal conditioning, frequency filtering and/or signal transformations. The vibration sensor data may be processed by the controller 36, at box 86, using the modeling software 44, which may be configured to perform any of the processing steps identified above, to generate simulated data. For example, the controller 36, and modeling software 44, may receive the vibration sensor data, perform one or more processing functions, and execute one or more models 48 to generate simulated data, which may include projected data and may be useful in identifying an abnormal operating condition of one of the front bearing 22 and the rear bearing 24.

At box 88, the simulated data may be filtered one or more times using frequency-based filtering to obtain filtered data. That is, the simulated data may be band-pass filtered to remove frequencies outside a range of interest, or wavelet analysis may be used to divide a given function or signal into different scale components. The frequency range for the band-pass filtering or wavelet analysis can be adjusted based on different operating conditions, such as engine speed and/or location of the failure. For example, under a different operating condition, the frequency range might be adjusted to correspond to the different operating condition. Different formulas, taking into account engine speed and/or other operating conditions, may be used to identify a frequency range.

Frequency domain information of the filtered data may be compared, at box 90, to threshold data to identify the abnormal operating condition. According to some embodiments, peak to peak values (or changes between highest amplitude and lowest amplitude) of the frequency domain information of the filtered data may be calculated and compared with threshold values (from the threshold data) to identify the abnormal operating condition. For example, the amplitude of a failed or failing component may be noticeably greater than the amplitude of a component operating normally. A predetermined timer or integrated strategy can be used for the threshold trigger to avoid the oscillation of the trigger event. That is, instances of an error may be accumulated, or may continue, until a threshold amount of instances is reached, or until a time is reached. Thereafter, the method may proceed to an END, at box 92.

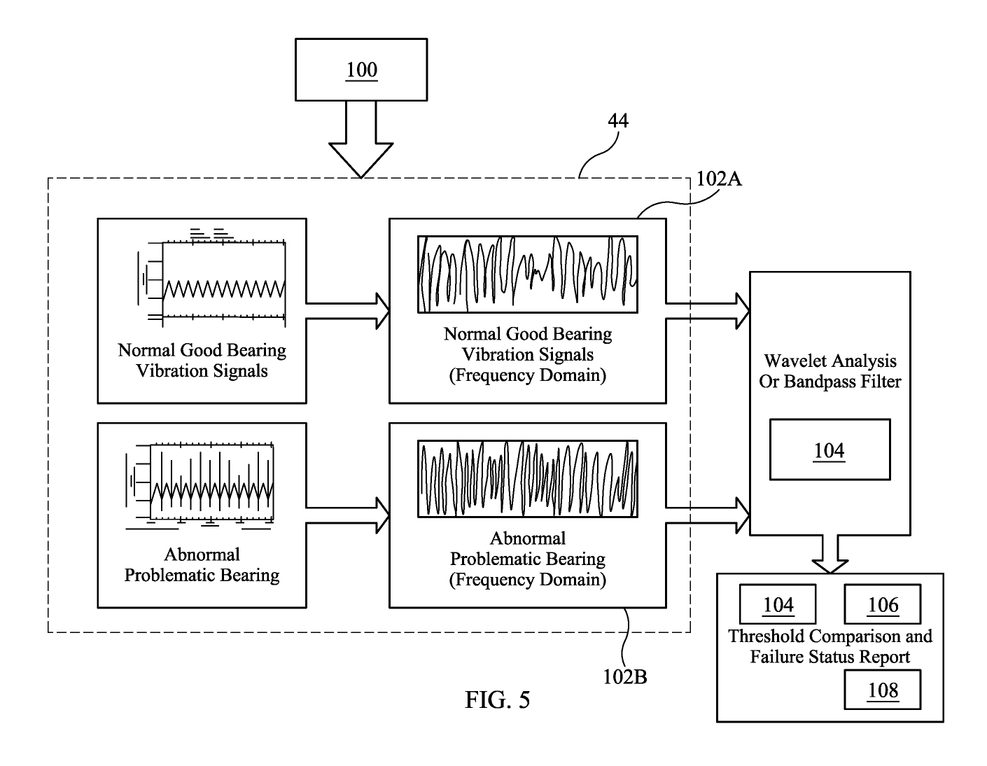

Turning now to FIG. 5, the exemplary method of FIG. 4 is illustrated another way. Vibration sensor data 100 may be used by the controller 36 (FIG. 1) to perform processing or simulation using the modeling software 44 to generate simulated data 102a and 102b. According to the exemplary embodiment, simulated data 102a may represent exemplary data corresponding to a bearing, such as front bearing 22 or rear bearing 24, experiencing a normal operating condition, while simulated data 102b may correspond to a bearing, such as front bearing 22 or rear bearing 24, experiencing an abnormal operating condition. The simulated data 102a and 102b may be filtered using frequency-based filtering, such as wavelet analysis or band-pass filtering, to obtain filtered data 104. Frequency domain information, or peak to peak values, of the filtered data 104 may be compared to threshold data 106 to identify the existence of an abnormal operating condition 108.

The system 28 and method of the present disclosure can be used to identify abnormal operating conditions of various components of the genset power system 10. Further, the system 28 and method of the present disclosure, including modeling software 44, may be used to identify mounting locations for a plurality of vibration sensors, such as vibration sensors 32, configured to identify abnormal operating conditions associated with particular genset power system components. The mounting locations may be identified for detecting abnormal operating conditions of particular components.

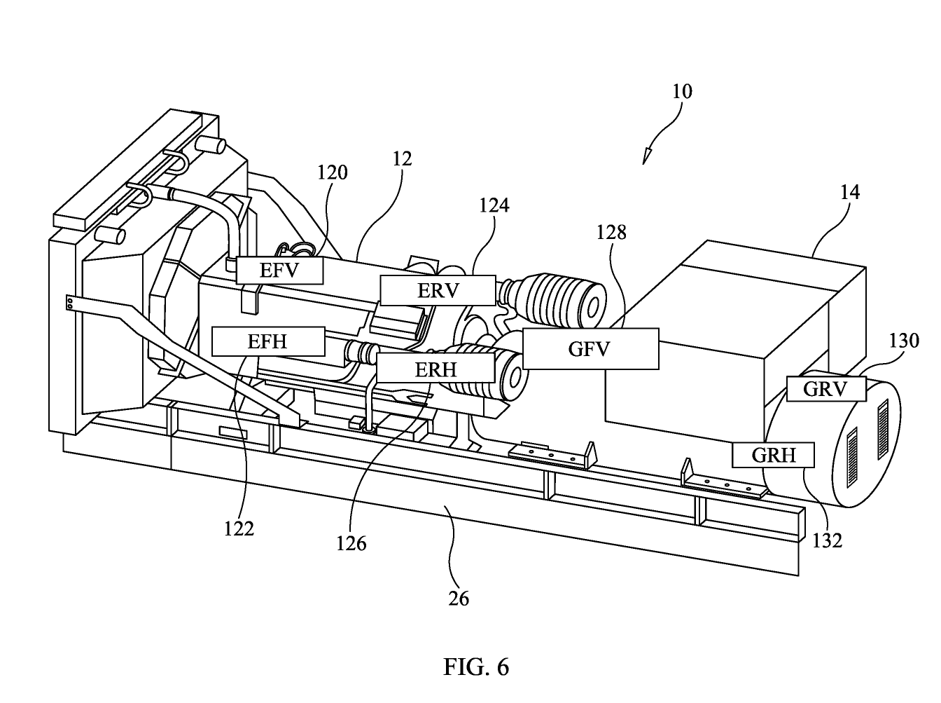

Exemplary mounting locations, shown in FIG. 6, may include an engine front vertical mounting location 120, an engine front horizontal mounting location 122, an engine rear vertical mounting location 124, an engine rear horizontal mounting location 126, a generator front vertical mounting location 128, a generator rear vertical mounting location 130, and a generator rear horizontal mounting location 132. The mounting locations may be identified through testing and analysis. That is, for example, a mounting location for detecting wear or failure of a particular component may be selected by analyzing data from sensors at different mounting locations and identifying the one providing the greatest indication of wear or failure for the particular component.

For example, as indicated by the modeling software 44 of the system 28, a vibration sensor 32 positioned at the generator rear vertical mounting location 130 may generate data most useful in identifying an abnormal operating condition of the vibration isolation mount 26 of the genset power system 10. Further, vibration sensors 32 positioned at the engine front vertical mounting location 120 and the generator rear vertical mounting location 130 may be most useful in identifying unbalance of at least one of the engine crankshaft 16 and the generator rotor 20. These mounting locations may be identified by comparing vibration signals from the different locations and identifying the sensor that is most sensitive to detecting a failure mode, such as wear and/or failure.

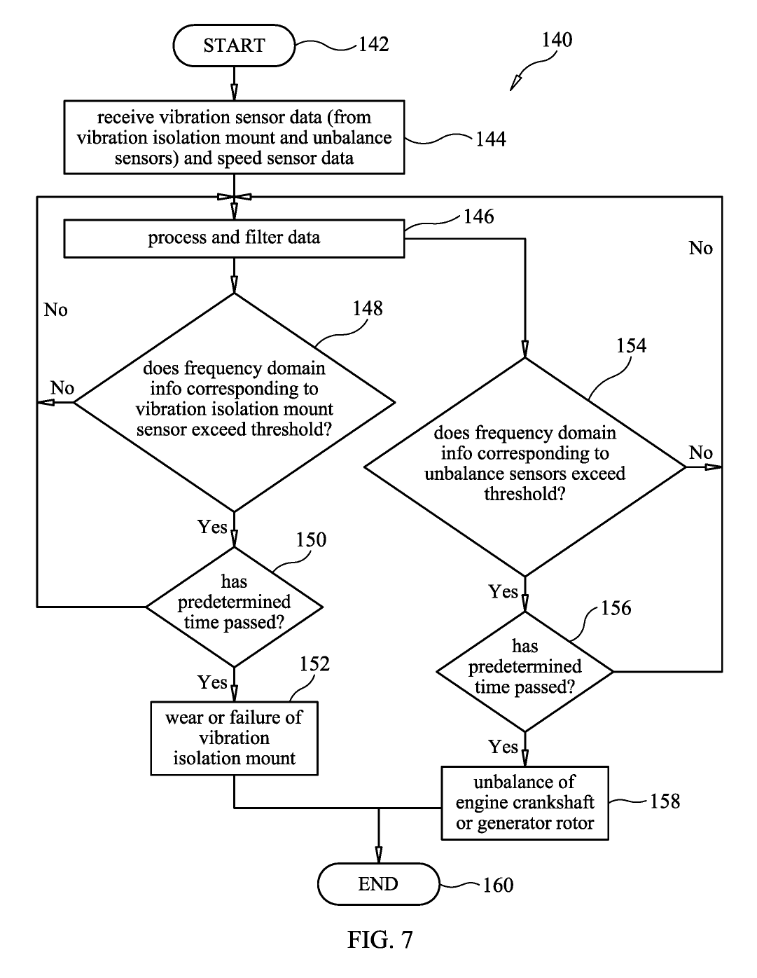

The controller 36 may communicate with vibrations sensors 32, including those positioned or mounted at the engine front vertical mounting location 120 and the generator rear vertical mounting location 130, to identify wear or failure of the vibration isolation mount 26 and/or unbalance of one of the engine crankshaft 16 and the generator rotor 20, according to a method disclosed herein, the steps of which are illustrated in a flow diagram 140 of FIG. 7. The method may be implemented in whole or in part by the controller 36 and may run, or execute, continuously or intermittently. The method may begin at a START, at box 142, and thereafter proceed to box 144.

According to the exemplary embodiment, vibration sensor data may be generated by vibration sensors 32 positioned at one or both of the engine front vertical mounting location 120 and the generator rear vertical mounting location 130, and speed sensor data may be generated by an engine speed sensor. The vibration sensor data and the speed sensor data may be received at the controller 36, at box 144. The vibration sensor data and speed sensor data may be processed by the controller 36, at box 146, such as by using the modeling software 44, and filtered, such as by using frequency-based filtering to obtain filtered data.

Frequency domain information of the filtered data, particularly with respect to at least one vibration isolation mount sensor (e.g., a vibration sensor 32 positioned at the generator rear vertical mounting location 130), or peak to peak values thereof, may be compared, at box 148, to threshold data. If the threshold is not exceeded, the method returns to box 146. However, if the threshold is exceeded, the method proceeds to box 150. The method determines, at box 150, whether the frequency domain information varies from the threshold data by a predetermined amount for a predetermined period of time. If not, the method returns to box 146; however, if so, the method proceeds to box 152, at which the controller 36 identifies the existence of a wear or failure of the vibration isolation mount 26.

Frequency domain information of the filtered data, particularly with respect to at least one unbalance sensor (e.g., vibration sensors 32 positioned at the engine front vertical mounting location 120 and the generator rear vertical mounting location 130), may be compared, at box 154, to threshold data. If the threshold is not exceeded, the method returns to box 146. However, if the threshold is exceeded, the method proceeds to box 156. The method determines, at box 156, whether the frequency domain information varies from the threshold data a predetermined amount for a predetermined period of time. If not, the method returns to box 146; however, if so, the method proceeds to box 158, at which the controller 36 identifies an unbalance of the engine crankshaft 16 or the generator rotor 20. The controller 36 may be further programmed to log a message 54, as described above, corresponding to the abnormal operating condition when the frequency domain information varies from the threshold data by a predetermined amount for a predetermined period of time. The method may then proceed to an END, at box 160.

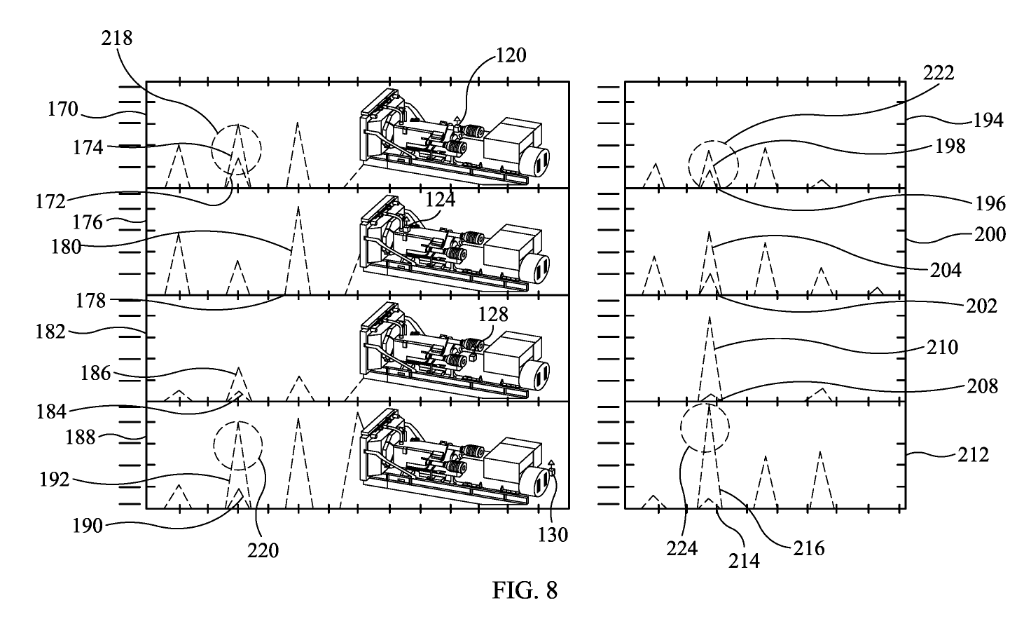

Turning now to FIG. 8, exemplary vibration data from vibration sensors 32 mounted at the engine front vertical mounting location 120, the engine rear vertical mounting location 124, the generator front vertical mounting location 128, and the generator rear vertical mounting location 130 is illustrated. In particular, chart 170 depicts exemplary vibration data from a vibration sensor 32 mounted at the engine front vertical mounting location 120, with a first curve 172 corresponding to a balanced crankshaft and a second curve 174 corresponding to an unbalanced crankshaft. Chart 176 depicts exemplary vibration data from a vibration sensor 32 mounted at the engine rear vertical mounting location 124 with a first curve 178 corresponding to a balanced crankshaft and a second curve 180 corresponding to an unbalanced crankshaft.

Chart 182 depicts exemplary vibration data from a vibration sensor 32 mounted at the generator front vertical mounting location 128, with a first curve 184 corresponding to a balanced crankshaft and a second curve 186 corresponding to an unbalanced crankshaft. Chart 188 depicts exemplary vibration data from a vibration sensor 32 mounted at the generator rear vertical mounting location 130, with a first curve 190 corresponding to a balanced crankshaft and a second curve 192 corresponding to an unbalanced crankshaft.

Chart 194 depicts exemplary vibration data from a vibration sensor 32 mounted at the engine front vertical mounting location 120, with a first curve 196 corresponding to a balanced rotor and a second curve 198 corresponding to an unbalanced rotor. Chart 200 depicts exemplary vibration data from a vibration sensor 32 mounted at the engine rear vertical mounting location 124 with a first curve 202 corresponding to a balanced rotor and a second curve 204 corresponding to an unbalanced rotor.

Chart 206 depicts exemplary vibration data from a vibration sensor 32 mounted at the generator front vertical mounting location 128, with a first curve 208 corresponding to a balanced rotor and a second curve 210 corresponding to an unbalanced rotor. Chart 212 depicts exemplary vibration data from a vibration sensor 32 mounted at the generator rear vertical mounting location 130, with a first curve 214 corresponding to a balanced rotor and a second curve 216 corresponding to an unbalanced rotor.

Based on peaks 218 and 222, and 220 and 224, for example, it may be determined that vibration data from the engine front vertical mounting location 120 and the generator rear vertical mounting location 130 may be most useful in identifying unbalance of the engine crankshaft 16 and/or generator rotor 20. That is, a peak to peak value, or a difference between the maximum positive and maximum negative amplitudes, at a specified frequency range, may be greatest from vibration data from sensors at the engine front vertical mounting location 120 and the generator rear vertical mounting location 130 during an abnormal operating condition.

The identification of the abnormal operating condition may occur if the peak to peak values reach or exceed a certain predetermined level, which may be established after research or analysis. During data analysis of sensor data from sensors mounted at different mounting locations of the genset power system 10, the engine front vertical mounting location 120 and the generator rear vertical mounting location 130 may be identified as being most sensitive to unbalance of the engine crankshaft 16 and unbalance of the generator rotor 20, respectively. Prognostics capabilities may also be available to predict wear or failure of a genset component and send an alert based on the prediction.

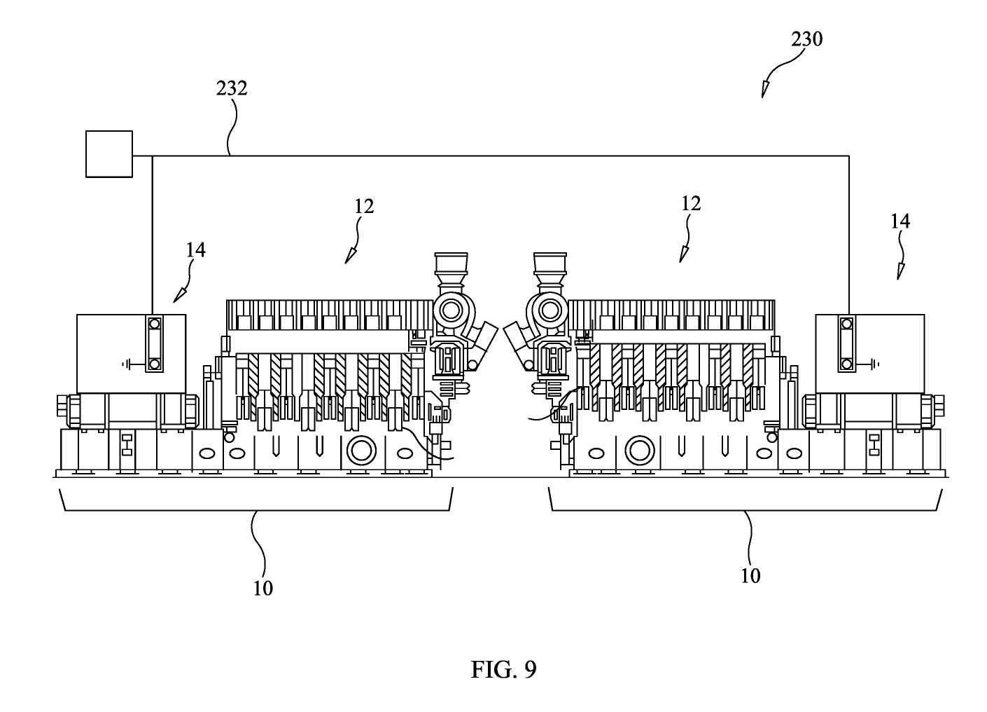

Turning now to FIG. 9, a power system 230 including a plurality of genset power systems 10 is shown. Although two genset power systems 10 are shown, it should be appreciated that the power system 230 may include any number of genset power systems 10. The power system 230 is configured to supply electrical power to a load, as is known to those skilled in the art. The power system 230 may be a stationary land-based power plant, for example, or the prime mover of a mobile land or marine based machine. The power system 230 may include a power transmission network, such as a common bus 232, for transferring electrical power from the genset power systems 10 to the load.

According to the present disclosure, the controller 36 may be further programmed to apportion a particular amount of load to one genset power system 10 of the power system 230 based on the abnormal operating condition, as identified above. That is, for example, less of a load may be apportioned to a genset power system 10 experiencing an abnormal operating condition. Rather than operating all the genset power systems 10 at the same level, it may be beneficial to reduce the load apportioned to the genset power system 10 experiencing a problem or potential problem. As such, further damage might be avoided. Further, the controller 36 may be programmed to set availability of one genset power system 10 of the plurality of genset power systems 10 based on the abnormal operating condition. That is, for example, a genset power system 10 experiencing an abnormal operating condition may be taken off-line and identified as “unavailable” until the abnormal operating condition is remedied/alleviated. The controller 36 may be configured to automatically modify the load apportioned to a particular genset power system 10 or modify the availability of the genset power system 10 experiencing an abnormal operating condition, and/or generate a message prompting a user to take action.

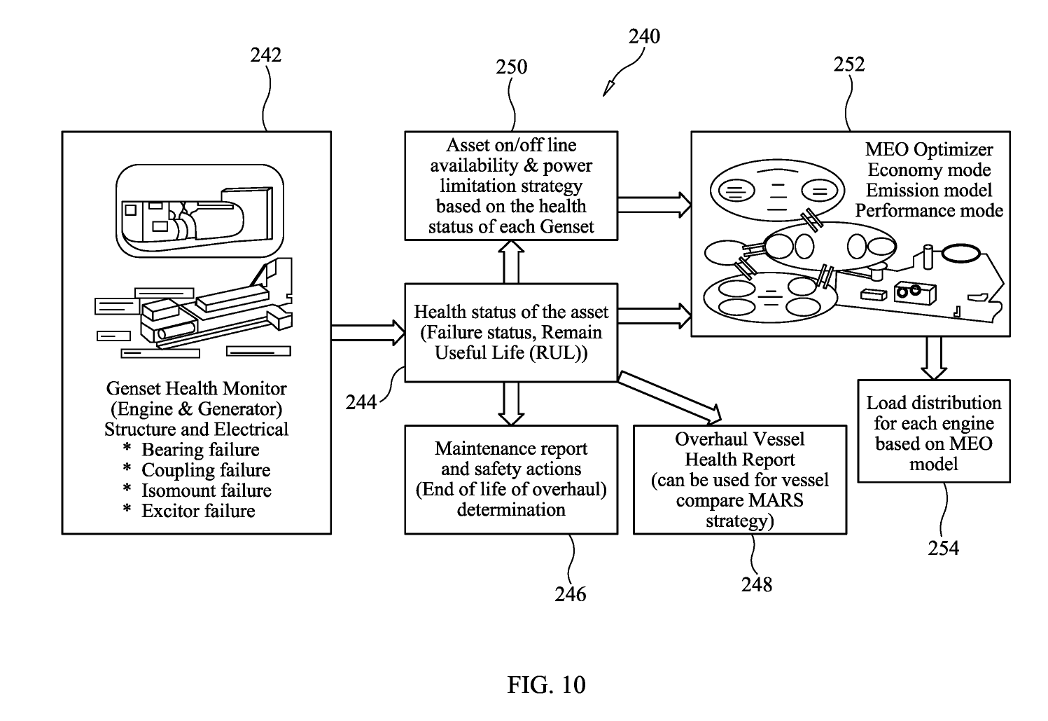

An exemplary health monitor system 240 for a system incorporating a genset power system 10 is shown in FIG. 10. That is, the health monitor system 240 may incorporate aspects of the system 28 and method of the present disclosure for detecting an abnormal operating condition of a genset power system component. In particular, the health monitor system 240 may include a genset health monitor module 242, which may include the strategy of the present disclosure for detecting an abnormal operating condition of a genset power system component.

The genset health monitor module 242 may provide input to an asset health status module 244, which may calculate or determine the remaining useful life of system components. The asset health status module 244 may provide input to a maintenance report and safety actions module 246 and an overall vessel health report module 248, both of which may provide useful information for analyzing the system monitored by the health monitor system 240. The asset health status module 244 may also provide input to an asset availability and power limitation strategy module 250 and an optimizer module 252, both of which may optimize system operation based on the diagnostic or prognostic information received. The optimizer module 252 may provide input to a load distribution module 254, which may optimize load sharing or load balancing based on various considerations, including, for example, economy, emissions, and/or performance.

### INDUSTRIAL APPLICABILITY

The present disclosure relates generally to genset power systems. More particularly, the present disclosure relates to detection of an abnormal operating condition of a genset power system component. Yet further, the present disclosure is applicable to a system and method for using model-based detection, including frequency-based filtering to detect the abnormal operating condition.

Excessive loading, and/or other operating conditions, of a genset can cause vibrations, which may result in undesirable effects on components of the genset. For example, excessive loading may cause premature wear or failure of genset components, which may result in unplanned downtime of the genset. Thus, to optimize operation thereof, it may be desirable to accurately and effectively detect or predict the occurrence of various abnormal operating conditions of the genset such that actions may be taken to reduce undesirable effects on the genset.

Referring generally to FIGS. 1-10, an exemplary genset power system 10 according to the present disclosure is shown generally in FIG. 1. The genset power system 10, which may be mounted on a vibration isolation mount 26, may include an engine 12 drivingly coupled to a generator 14. The engine 12 may include a plurality of cylinders, each having a piston connected to a common crankshaft 16. The engine 12, or crankshaft 16, may be mechanically coupled to the generator 14 via a coupling 18. The generator 14 may receive mechanical power from the engine 12, by way of the coupling 18, and convert at least a portion of the mechanical power into electrical power using a rotor 20. The generator 14 may also include a front bearing 22 and a rear bearing 24.

A system for detecting an abnormal operating condition of a component of the genset power system 10 is shown generally at 28. The system 28 may include various sensors 30, including at least one vibration sensor 32. The system 28 may also include a control system 34, including a controller 36, for electronically monitoring and/or controlling the various machine systems and components. The control system 34 may include or access modeling software 44 for performing a variety of functions or tasks. For example, the modeling software 44 may be used to assist in detecting abnormal operating conditions of components of the genset power system 10. The control system 34 may also include or access a database 46. The database 46, and/or memory 40, may be accessed by the controller 36 to implement various monitoring and/or control strategies for the genset power system 10.

According to a specific example, the controller 36 may communicate with a first sensor 70 and a second sensor 74, which may be configured to detect vibrations of the front and rear bearings 22, 24, and may be programmed to identify wear and/or failure of the front bearing 22 and/or rear bearing 24, according to a method disclosed herein, the steps of which are illustrated in a flow diagram 80 of FIG. 4. Vibration sensor data may be generated by the first sensor 70 and the second sensor 74, such as during operation of the genset power system 10, and may be received at the controller 36, at box 84. The vibration sensor data may be processed by the controller 36, at box 86, using the modeling software 44, which may be configured to perform any of the processing steps identified above, to generate simulated data.

At box 88, the simulated data may be filtered, or further filtered, using frequency-based filtering to obtain filtered data. That is, the simulated data may be band-pass filtered to remove frequencies outside a range of interest, or wavelet analysis may be used to divide a given function or signal into different scale components. Frequency domain information, or peak to peak value information, of the filtered data may be compared, at box 90, to threshold data to identify the abnormal operating condition. As such, the diagnostics and prognostics of the present disclosure may be useful for early detection of issues and, thus, avoidance of catastrophic failure of components and systems. The issues, or defects, may produce additional force that may be detected using vibration sensors positioned at mounting locations, as disclosed herein.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A system for detecting an abnormal operating condition of a component of a genset power system, including:
the genset power system including an engine drivingly coupled to a generator;
at least one vibration sensor configured to measure vibrations of the genset power system; and
a controller programmed to:
receive vibration sensor data from the vibration sensor;
process the vibration sensor data using a modeling software to generate simulated data;
filter the simulated data using frequency-based filtering to obtain filtered data; and
compare frequency domain information of the filtered data to threshold data to
identify the abnormal operating condition of the component.

2. The system of claim 1, wherein the controller is further programmed to identify the abnormal operating condition as an abnormal operating condition of a bearing of the genset power system based on the frequency domain information, wherein the abnormal operating condition includes wear or failure.

3. The system of claim 2, wherein the at least one vibration sensor includes a first sensor mounted on a front generator bearing bracket of the generator, which is identified as a first mounting location sensitive to the abnormal operating condition, and a second sensor mounted on a rear generator bearing bracket of the generator, which is identified as a second mounting location sensitive to the abnormal operating condition, and wherein the first sensor and the second sensor are configured to generate the vibration sensor data.

4. The system of claim 1, wherein the controller is further programmed to identify the abnormal operating condition as an abnormal operating condition of a vibration isolation mount of the genset power system based on the frequency domain information, wherein the abnormal operating condition includes wear or failure.

5. The system of claim 4, wherein the at least one vibration sensor includes a generator rear vertical sensor configured to generate the vibration sensor data.

6. The system of claim 1, wherein the controller is further programmed to identify the abnormal operating condition as an abnormal operating condition of at least one of a crankshaft of the engine and a rotor of the generator based on the frequency domain information, and wherein the abnormal operating condition includes unbalance of the crankshaft or the rotor.

7. The system of claim 6, wherein the at least one vibration sensor includes at least one of an engine front vertical sensor and a generator rear vertical sensor configured to generate the vibration sensor data, wherein the engine front vertical sensor and the generator rear vertical sensor are identified as mounting locations sensitive to the abnormal operating condition.

8. The system of claim 1, wherein the controller is further programmed to use the modeling software to identify a mounting location for the at least one vibration sensor.

9. The system of claim 1, wherein the controller is further programmed to log a message corresponding to the abnormal operating condition when the frequency domain information varies from the threshold data a predetermined amount for a predetermined period of time.

10. The system of claim 1, further including a plurality of genset power systems, wherein the controller is further programmed to apportion a particular amount of load to one genset power system of the plurality of genset power systems based on the abnormal operating condition.

11. The system of claim 1, further including a plurality of genset power systems, wherein the controller is further programmed to set availability of one genset power system of the plurality of genset power systems based on the abnormal operating condition.

12. A method for detecting an abnormal operating condition of a component of a genset power system, wherein the genset power system includes an engine drivingly coupled to a generator, the method including:
operating the genset power system to produce an electrical output;
measuring vibrations of the genset power system using a vibration sensor;
generating vibration sensor data using the vibration sensor;
receiving vibration sensor data from the vibration sensor at a controller;
processing the vibration sensor data by the controller using a modeling software to generate simulated data;
filtering the simulated data by the controller using frequency-based filtering to obtain filtered data; and
comparing frequency domain information of the filtered data to threshold data by the controller to identify the abnormal operating condition of the component.

13. The method of claim 12, further including identifying the abnormal operating condition as an abnormal operating condition of a bearing of the genset power system based on the frequency domain information, wherein the abnormal operating condition includes wear or failure.

14. The method of claim 12, further including identifying the abnormal operating condition as an abnormal operating condition of a vibration isolation mount of the genset power system based on the frequency domain information, wherein the abnormal operating condition includes wear or failure.

15. The method of claim 12, further including identifying the abnormal operating condition as an abnormal operating condition of at least one of a crankshaft of the engine and a rotor of the generator based on the frequency domain information, and wherein the abnormal operating condition includes unbalance.

16. The method of claim 12, further including logging a message corresponding to the abnormal operating condition when the frequency domain information varies from the threshold data a predetermined amount for a predetermined period of time.

17. A control system for detecting an abnormal operating condition of a component of a genset power system, wherein the genset power system includes an engine drivingly coupled to a generator, the control system including:
a controller programmed to:
receive vibration sensor data from a vibration sensor configured to measure vibrations of the genset power system;
process the vibration sensor data using a modeling software to generate simulated data;
filter the simulated data using frequency-based filtering to obtain filtered data; and
compare frequency domain information of the filtered data to threshold data to
identify the abnormal operating condition.

18. The control system of claim 17, wherein the controller is further programmed to use the modeling software to identify a mounting location for the at least one vibration sensor.

19. The control system of claim 17, wherein the controller is further programmed to apportion a particular amount of load to one genset power system of a plurality of genset power systems based on the abnormal operating condition.

20. The control system of claim 17, wherein the controller is further programmed to set availability of one genset power system of a plurality of genset power systems based on the abnormal operating condition.
